(19) United States
(12) Patent Application Publication
(10) Pub. No.: US 2007/0172085 A1
(43) Pub. Date: Jul. 26, 2007

(54) Theater center apparatus

(76) Inventor: Art Powers, White Plains, NY (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/341,318

(22) Filed: Jan. 26, 2006

(51) Int. Cl. H04R 5/02

(52) U.S. Cl. 381/303; 381/300

(57) ABSTRACT

The theater center apparatus has a top and a bottom arranged parallel to the top. An intermediate platform is arranged parallel to the top and bottom and is located to form a horizontally extending intermediate chamber between the top and the intermediated platform. At least one pair of speakers is located in the intermediate chamber and positioned to provide a pseudo surround sound effect.

### BACKGROUND

1. Field of the Invention

The present invention relates to enclosures for electronics equipment. More specifically, the present invention relates to a compact enclosure configured to house a plurality of theater component electronics so as to create a pseudo surround sound effect.

2. Description of the Related Art

Twenty five years ago, only a small percentage of households in the United States had cable television and VCRs were a brand-new luxury item. Sound systems, for the most part, were limited to the small speaker built into the television, and not many people had a screen larger than 27 inches. There was certainly no mistaking the typical TV experience for a theater—theaters were enhanced environments with film projectors, wide screens and sound systems to provide a better audio-visual experience for movies, for example. There are a few main components that have historically made watching TV and going to the movies very different.

One of the biggest differences is the sound experience. In a quality movie theater, the music, sound effects and dialogue come not just from the screen, but from all around the viewer. For example, a movie theater might typically have three speakers behind the screen—one to the right, one to the left and one in the center and several other speakers spread out in the rest of the theater to create a surround sound effect.

The second chief component of the theater experience is the large size of the movie screen. In a theater, the screen takes up most of the field of view, which makes it very easy to lose yourself in the movie.

Film projectors present very large, clear pictures. The detail is much sharper than on an ordinary television, and the movement is much more fluid. Although perhaps not consciously recognized, the image quality does make a significant difference in the enjoyment of a movie. With detail, viewers are more engrossed in the world of the movie.

These days, many U.S. households can receive digital and high definition television programming, and have a good-sized color television and a video recording device. A variety of component electronics are available for audio-visual applications and conventionally include multiple, free-standing enclosures that receive power and signals from facility wiring and communicate with other components on wired cables or wireless links. Advanced components, such as plasma TVs, raise the quality of audio-visual applications towards that of theater systems. A typical sound surround system is illustrated in FIG. 1 and incorporates at least five speakers: front right and left speakers, rear right and left speakers, a front center speaker and a sub-woofer, low frequency speaker, requiring that a number of loudspeakers be placed throughout the viewing room, on all sides of the listener/viewer, in order to achieve the desired audio effects. As a result, a multitude of speaker wires must be run throughout the room and the. housing of each speaker that can be extremely difficult to accomplish. Also, the fact that there is an individual channel associated with each of the surround sound speakers that makes attaching a speaker wire to the correct receiver output channel and speaker equally troublesome. In addition, a conventional system includes amplifiers, TV sets, such as a big-screen plasma TV and others, all contributing to a large space which is necessary to incorporate all components.

Support for numerous components related to audio-visual application has conventionally been provided by furniture called an entertainment center. A conventional entertainment center may have open shelving and enclosed shelving for supporting and enclosing not only the electronic components but also media used with the components. Typically, such an entertainment center provides movable shelving for accommodating consumer electronics assemblies of different vertical height; but has fixed horizontal dimensions designed for a maximum component width. Thus, the use of the conventional entertainment center is limited by the fixed horizontal width of its design. Listeners seeking, for example, to accommodate a larger home theater display (e.g., big speakers) have little recourse but to purchase new furniture in the event the larger width display does not fit the fixed horizontal width provided by existing entertainment centers.

New products of various sizes are launched into this market annually. Without furniture capable of accommodating different horizontal widths, consumers may be reticent to purchase more expensive entertainment center furniture or may forego the acquisition of newer larger components. Consequently, both the consumer electronics and furniture industries face significant economic impairments to growth in sales.

When speakers are not as attractive as desirable or take up too much space in a room, the speakers might be mounted in the wall. When speakers are mounted in a wall using conventional mounting apparatus, the sound dispersion axis of each speaker is directed in a perpendicular direction to the plane formed by the vertical wall. Thus, only one location in the room may receive sound with an optimum quality. If a surround sound system has at least some of the speakers suspended to the walls at particular locations, changing the locations requires remounting of the speakers, which is time-consuming and expensive. Moreover, the quality of the sound supplied at the new chosen location may not meet the listener's expectations.

Current surround sound systems require the use of four to six speakers (channels) strategically positioned within a room to achieve an even more realistic environment. The known surround process involves encoding multiple channels of information—Front Left, Center, Front Right, and Rear Surround into a two channel signal. The rear surround channel employs two or more speakers, which are typically passing a monophonic signal, limiting rear-to-front and side-to-front motion and sound placement cues. An audio surround sound system may be wireless or wired and configured with as many speakers as the listener wishes to purchase to satisfy his/her musical taste. As the number of simultaneous but discrete sound sources increase in a surround sound system, the surround sound quality becomes more realistic but it also becomes more difficult to place speakers in a room so that they blend in with the room's decor. In addition, the optimum listening area becomes more focused and therefore, it becomes more difficult for multiple listeners to experience the optimal surround sound experience.

A need, therefore, exists for an audio-video entertainment system that incorporates relatively few electronic components capable of providing a pseudo surround sound effect.

Another need exists for an entertainment center that is configured to house all of the components of the audio-video system.

Still another need exists for the entertainment center that is configured to allow the listener to position numerous speakers of the entertainment audio-video system so as to create the pseudo surround sound effect.

A further need exists for the entertainment theater center that has an appearance of a regular piece of furniture and is designed to camouflage the audio system housed therein while featuring a compact structure.

The above, and other objects, features and advantages of the present invention will become apparent from the following description read in conduction with the accompanying drawings, in which like reference numerals designate the same elements.

### BRIEF SUMMARY

The present invention is directed to an entertainment center that satisfies these needs and attains the following objects, in which one of the objects of the present invention is to provide the home theater center remediating the detriments and concerns noted above.

Another object of the present invention is to provide the home theater center that can be viewed as an aesthetically appealing piece of furniture camouflaging the stored electronic equipment from an audience.

Still a further object of the present invention is to provide the home theater center configured to receive a group of loudspeakers in a manner, which allows an audio system to create a pseudo surround sound effect.

A further object is of the present invention is to provide a home theater center configured with a horizontally extending chamber that can receive and store variously shaped speakers.

The above, and other objects, features and advantages of the present invention will become apparent from the following description read in conduction with the accompanying drawings, in which like reference numerals designate the same elements.

### BRIEF DESCRIPTION OF THE DRAWINGS

FIG. 1 is a typical layout of a conventional surround sound audio system.

FIG. 2 is a descriptive view of a theater center configured in accordance with an embodiment of the present invention.

FIG. 3 is a diagrammatic top view of a horizontally extending chamber, which is formed in the entertainment theater center embodiment of FIG. 2, illustrating one of the aspects of the embodiment that allows the audio system stored in the chamber to produce a pseudo surround sound effect.

FIG. 4 is a diagrammatic top view of the horizontally extending chamber, which is formed in the entertainment theater center embodiment of FIG. 2, illustrating one of the aspects of the embodiment that allows the audio system stored in the chamber to produce a pseudo surround sound effect.

FIG. 5 is a diagrammatic top view of the horizontally extending chamber, which is formed in the entertainment theater center embodiment of FIG. 2, illustrating one of the aspects of the embodiment that allows the audio system stored in the chamber to produce a pseudo surround sound effect.

FIG. 6 is a diagrammatic front view of the home theater center configured in accordance with a further embodiment of the invention.

FIG. 7 is a diagrammatic partially sectioned front view of the theater center embodiment shown in FIG. 2.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps.

The drawings are in simplified form and are not to precise scale. For purposes of convenience and clarity only, directional terms, such as top, bottom, left, right, up, down, over, above, below, beneath, rear, and front may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices. In addition, such terms as “bay” and “chamber” are used interchangeably.

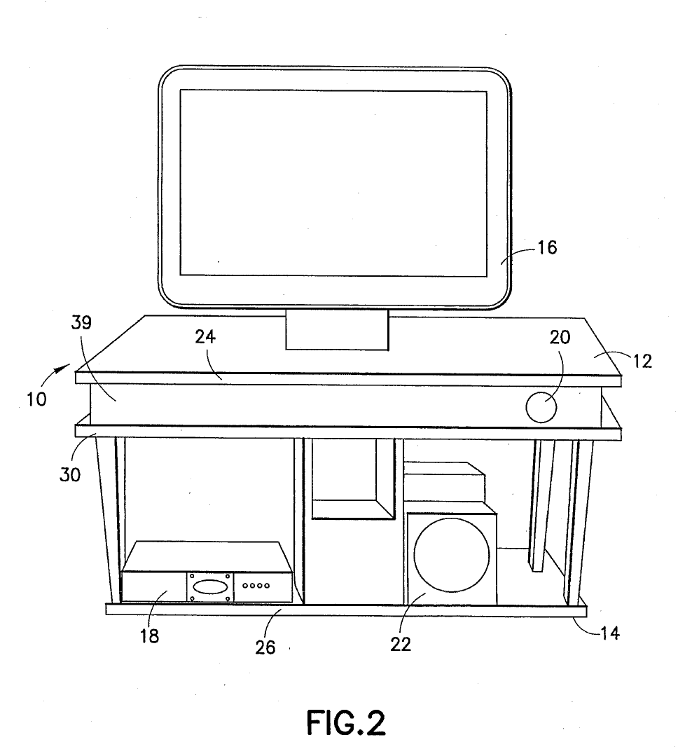

A theater center apparatus 10, as shown in FIG. 2, is configured to house a theater system that borrows from both the image and sound technology of the movie theater and adapts the borrowed features to a smaller environment so as to provide the listener with a close to the movie theater experience. The theater entertainment center is configured to house variously shaped and dimensioned electronic components so as to create a pseudo surround sound effect. The theater center includes a housing variably dimensioned and shaped, but, overall, having a compact structure sufficient to receive and store a plurality of electronic components. For example, the housing can store a plasma screen TV 16, one or more DVD players and/or HiFi VCR, stereo or AV receiver 18, amplifier and a plurality of low frequency, mid-range, and high frequency speakers 20 and 22. To fully accommodate a large screen TV, the theater center may have a mechanism for raising and lowering the TV relative to the housing. Theater center 10 can be placed in just about any suitable location such as a house, a small apartment, office, dorm, or even outside.

Referring now to FIG. 2, theater center 10 includes a top 12 and a bottom 14 that coextend with one another and are dimensioned so that their width generally corresponds to or is slightly greater than a width of audio components housed within center 10. As shown, top and bottom 12 and 14, respectively, have generally a polygonal cross-section, but any other regular or irregular shape may be used so long as it is wide enough to have the theater system neatly arranged in center 10. For example, the housing may be shaped to imitate a credenza, buffet, side board or any other familiar piece of furniture that, typically, is not associated with many of the known box-like entertainment centers. Decorating the theater housing provides for an aesthetically appealing piece of furniture without, however, exhibiting the electronic equipment that is stored inside the housing.

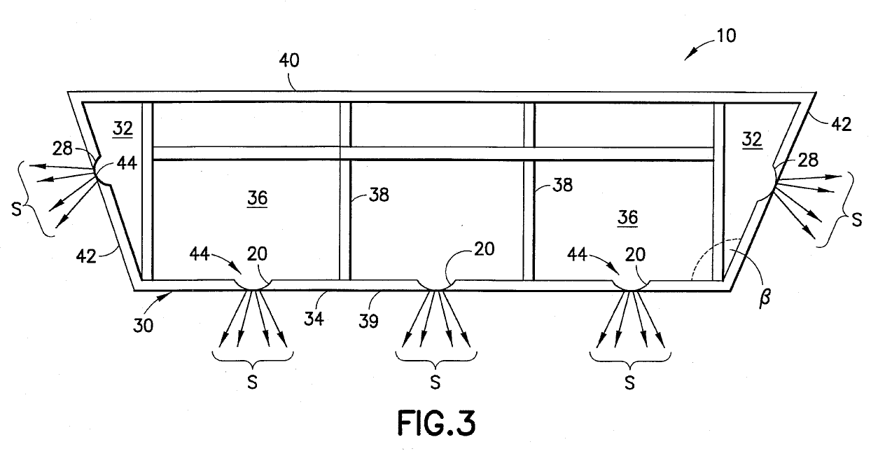

As mentioned above, a surround sound system may have certain disadvantages associated with space and cost considerations. To minimize these disadvantages while not losing much in the quality of the surround sound effect, speakers 20 are strategically positioned in the housing to create a pseudo sound surround effect. In particular, end speakers 28, better seen in FIG. 3 and defining opposite stretches of a row of speakers 20, each are placed in a respective plane extending outwardly from a diagonal plane of home theater center 10, which is defined by front and bottom edges 24 and 26 (FIG. 2) of top 12 and bottom 14, respectively, of theater center 10. As a consequence, the sound emanating from end speakers 28 projects along the sidewalls of the room towards the wall behind the listener and bounces back towards the listener. Thus, although the system does not have a sound source positioned behind the listener, the angular position of end speakers 28 allows them to create the sound enveloping the listener and creating the effect, which is comparable with the surround sound effect.

The above-disclosed pseudo surround sound effect is preferably realized by configuring theater center 10 with a horizontal chamber parallel to and between the top 12 and bottom 14, extending between opposite end sides of the theater center, and defined by an intermediate platform 30 coextending with the top 12 and bottom 14. Preferably, the horizontally extending chamber is shaped and dimensioned, and has a uniform height corresponding to, or slightly greater than, the vertical dimension of the speakers, which are thus compactly placed within the housing. The top 12 and intermediate platform 30 thus define a sandwich structure for the speakers.

Preferably, intermediate platform 30 is located closer to the top of theater center 10 than to its bottom; however, based on the specific requirements of the listener, the spatial relationship between the platform and the top may be changed by having the platform located closer to the bottom of theater center 10. In either modification, a distance between platform 30 and the closest one of the bottom and top is selected so that speakers 20 and 28 can be inserted within the horizontally extending chamber in a manner limiting their voluntary displacement in a vertical plane. Accordingly, platform 30, a row of speakers 20 and 28 and, for example, top 12 define a sandwich structure configured so that the speakers are capable of generating the pseudo surround sound effect as explained above.

The speakers may be of various horizontal dimensions. A plurality of partitions 38 (FIG. 3) preferably divide the horizontal chamber into multiple bays, front peripheral wall 39 and rear wall 40. The horizontally extending chamber, thus, has a central region 34 (FIG. 3) and a pair of opposite wing regions 32 (FIG. 3) each lying in a respective plane, which extends horizontally transverse to the plane of the central region 34 and breaking away from the plane of central region 34. Such geometry defines a predetermined position of end speakers 28, in which they extend angularly with respect to the rest of speakers 20 thereby generating sound waves propagating towards a wall behind the listener and then reflecting therefrom so as to create the pseudo-surround sound effect.

To place end speakers 28 in the predetermined angular positions, each of wing regions 32 has a specific geometry differing from a generally rectangular shape of relatively short bays 36, which are formed in the horizontal chamber by spaced partitions 38. In accordance with the simplest geometrical solution, the embodiment shown in FIG. 3 has two wing regions 32 each delimited by rear wall 40 of home theater center 10, which may be removably or permanently mounted to the rest of the structure, front wall 39 of the horizontal chamber and a respective flank 42 bridging the rear and front walls. Front wall 39 and flanks 42 each are provided with openings 44 shaped and dimensioned to receive drivers of speakers 22 and 28 that, when mounted, do not extend beyond the outer surfaces of the front wall and flanks. Depending on a number of speakers and their configuration, the number of openings 44 within each relatively short vertical bays 36 and wing region 32 may vary to accommodate as many drivers of each speaker as necessary. Having flanks 42 extend angularly at a predetermined angle with respect to central region 34 of the horizontal chamber and be provided with openings 44 invariably defines the desired position of the drivers of end speakers 28, in which sound waves S propagate along the sidewalls of the room and further reflect from the wall, which is located behind the listener back towards the listener. The predetermined angle β at which flanks 42 extend rearwardly from central region 34 of the horizontally extending chamber may vary, but clearly has to be less than a right angle.

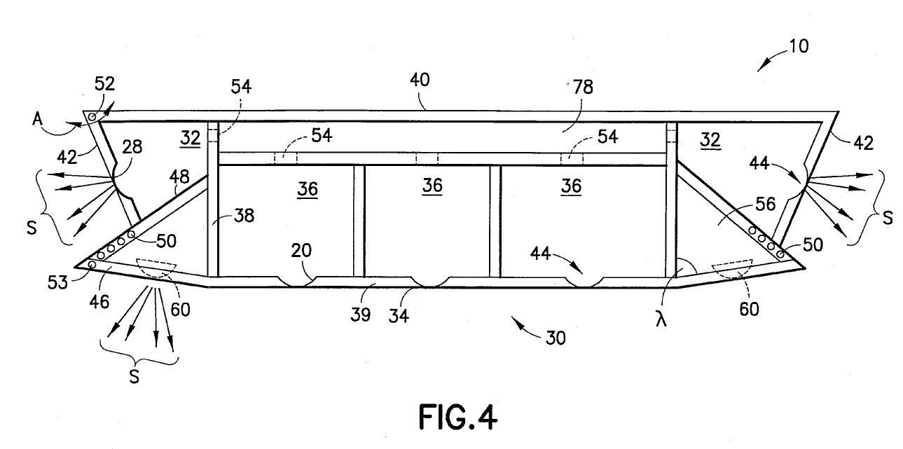

A further modification of wing regions 32 is illustrated in FIG. 4. By contrast with the embodiment of FIG. 3, front wall 39 of the horizontal chamber is configured with inner central region 34 and outer end regions 46 extending from the inner central region at a small angle λ of about 5°. Flanks 42 of wing regions 32 extend toward front wall 39 similarly to the embodiment illustrated in FIG. 3, but terminate at a distance therefrom. To provide a structure capable of withstanding vibrations, flanks 42 each are coupled to a respective reinforcing rib 48 connecting outer end regions 46 to adjacent partition 38.

Such a structure may have a few advantages. First, outer end regions 46 of front wall 39 each form a respective additional chamber 56 with rib 48. Since outer regions 46 are slightly slanted, placing an additional speaker 60 in each of these newly formed chambers contributes to the pseudo surround effect generated by side speakers 28. Moreover, since speakers 60 and 28 have respective drivers extending along non-parallel axes, incidence angles of sound waves S emanated from speakers 28 and 60 are also different. As result, these sound waves reflect from different areas of the wall behind the listener and may further enhance the pseudo surround sound effect.

Second, assuming that the listener may want to change the position of end speakers 28 in accordance with his/her preferences, the embodiment of FIG. 4 provides for displacement of flanks 42 relative to front wall 39 of the horizontal chamber. One of possible realizations of this concept may be implemented by pivotally mounting a rear end 52 of flanks 42 to rear wall 40 of theater 10 and displacing it in a direction, as shown by an arrow A. The opposite, front end of flanks 42 may be removably or slidably coupled to rib 48, which, in turn, is outwardly curved and provided with a plurality of openings 50. Pivoting flank 42 about its rear end 52 so that an opening or any other means for connecting flank 42 to ribs 48 is aligned with one of the openings 50 of course may adjust the incidence angle of sound waves S generated by end speakers 28. Alternatively, rib 48 may be straight, but, like flank 42, be pivotally mounted around a pivot 53 to regions 46 of front wall 39.

A further embodiment of wing regions 32 of the horizontal chamber is illustrated in FIG. 5 and includes a dove-shaped sidewalls configured of two inwardly converging flanks 42 and 64. Such a structure allows the listener to place two speakers 28 and 62 in each of the wing regions. It has been noted that reflecting sound waves S from the wall located in front of the listener (or behind rear wall 40 of home theater 10) may positively contribute in the overall quality of the pseudo sound effect. Accordingly, speakers 62 are positioned to face the room's area located generally behind theater 10 and emanate sound waves S that bounce from this area towards the listener.

A further aspect of the invention expands the above-disclosed pseudo surround sound concept even further. Each of the wing regions of the horizontally extending chamber has a respective dove-tailed cross-section defining, thus, two sub-regions on each side of the horizontally extending chamber that converge towards one another. Each of the sub-regions receives a respective speaker to even further enhance the pseudo sound surrounding effect by having sound waves bounce off not only the wall behind the listener, but also from the wall located in front of him.

Still another aspect of the present invention relates to a further arrangement of speakers within the horizontally extending chamber and having at least some of these speakers face a surface, which supports the home theater center. Such a position of the speakers within the sandwiched structure allows the sound waves to initially reflect from either the support surface before enveloping the room.

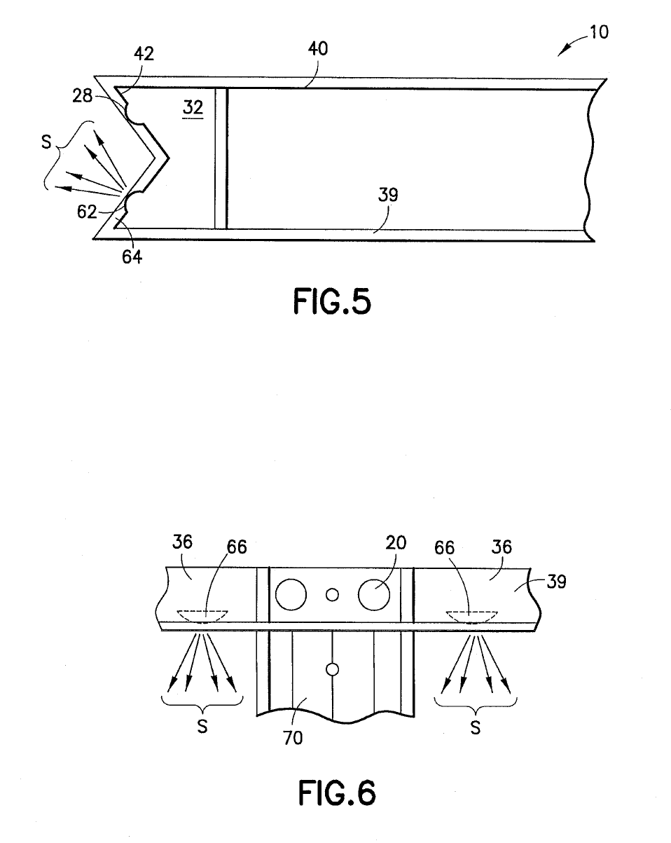

In accordance with a further embodiment, shown in FIG. 6, the horizontally extending chamber, in addition to speakers 20, 28 and, optionally 60 and 62 illustrated in FIGS. 3, 4 and 5, respectively, may be provided with speakers 66 located in relatively short bays 36 and having their drivers face the floor or any other support of theater center 10. Empirically, it has been found that such a configuration of speakers may also enhance he pseudo surround sound effect. As is seen in this figure, home theater center 10 is slightly modified as compared with one shown in FIG. 2. In particular, the home center has a T-shaped cross-section defined by a central stand that supports a horizontally extending chamber. Alternatively, the horizontal chamber may function as a base supporting the central stand.

In all of the above-disclosed embodiments, the horizontally extending chambers may be provided with a means for displacing partitions 38 (FIG. 3). Varying relative position of adjacent partition 38 provides a space for differently dimensioned speakers 20 (FIG. 2) located within central region 34 of the horizontally extending chamber.

Arranging multiple speakers and the rest of electronic equipment within the home theater, its housing may include a plurality of bays or chambers. Vertically elongated bays may be separated from one another by a plurality of vertical partitions defining therebetween a plurality of differently sized and dimensioned chambers that may or may not be covered by doors or by any fabric.

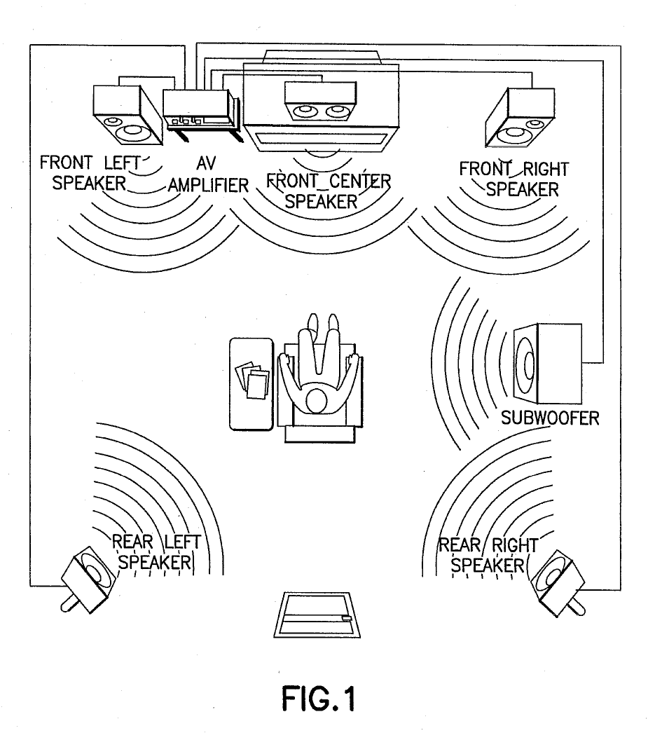

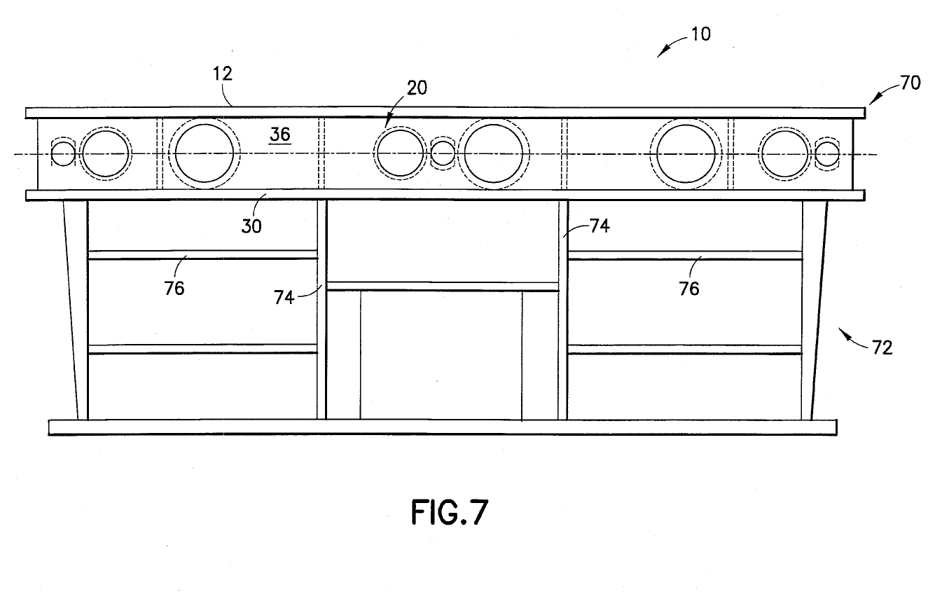

Turning now to FIG. 7, a vertical cross-sectional view of theater center 10, as shown in FIGS. 1-5, illustrates the sandwich structure 70 provided with the horizontally extending chamber, which extends from top 12 of theater center 10 towards platform 30 and has a plurality of short chambers 36, and a base portion 72. The base portion 72 is separated by a plurality of vertically and horizontally extending partitions 74, 76, respectively, defining a plurality of open and close compartments, each of which is dimensioned to receive a respective piece of electronic equipment. A central portion 74 may be provided with doors closing its interior. Briefly turning to FIG. 4, relatively short chambers 36 terminate at a distance from rear wall 40 of home theater center 10 leaving, thus, a space 78 dimensioned to receive numerous electric cables electrically connecting separate pieces of the electronic equipment. Those partitions that project into space 78 have apertures 54 allowing the cables to extend between adjacent regions of space 78. Similarly, the backside of bays 36 also has a plurality of apertures 54 guiding the electric cables into these chambers.

Space 78 also serves as a storage space for plasma screen or other relatively flat TV 16 (FIG. 2), which is displaceably mounted to home theater center 10 and is operative to rise above top 12 when the listener wants to see it. When TV 16 is not in use, the theater center has a means for displacing the TV into space 78. Once the TV is hidden in space 78, the home theater cannot be distinguished as a structure carrying the electronics.

Home theater 10 is a modular structure that can be easily assembled/disassembled into a plurality of components and purchased as a kit. While different combinations of assembleable components are envisioned within the scope of this invention, preferably, but not necessarily, the sandwich structure including top 12, platform 30, speakers 28 and 20 and front wall 39 are initially assembled together at a factory.

This document describes exemplary preferred embodiments of the inventive theater entertainment center for illustration purposes only. Neither the specific embodiments as a whole, nor their features limit the general principles underlying the invention. The specific features described herein may be used in some embodiments, but not in others without departure from the spirit and scope of the invention as set forth. Many additional modifications are intended in the foregoing disclosure, and it will be appreciated by those of ordinary skill in the art that in some instances some features of the preferred embodiments will be employed in the absence of a corresponding use of other features. The illustrative examples therefore do not define the metes and bounds of the invention.

What is claimed is:

1. A theater center apparatus, comprising:
a top;
a bottom arranged parallel to the top;
an intermediate platform arranged parallel to the top and bottom, and located between the top and bottom so as to form a horizontally extending intermediate chamber between the top and the intermediate platform; and
at least a pair of speakers located in the intermediate chamber and positioned to provide a pseudo surround sound effect.

2. A theater center apparatus as recited in claim 1, wherein said intermediate chamber is enclosed and said at least a pair of speakers is substantially obscured from view.

3. A theater center apparatus as recited in claim 2, wherein said pair of speakers are positioned to emit sound in a diagonal direction from the apparatus.

4. A theater center apparatus as recited in claim 3, wherein the intermediate chamber has a height which is just slightly more than the height of said at least a pair of speakers and said at least a pair of speakers are sandwiched in the chamber.

5. A theater center apparatus as recited in claim 4, wherein the intermediate chamber further comprises a front chamber wall, a rear chamber wall, and a plurality of partitions perpendicular to the front and rear chamber walls, said plurality of partitions dividing the intermediate chamber into multiple center bays and wing regions.

6. A theater center apparatus as recited in claim 5, wherein said wing regions contain said pair of speakers positioned to emit sound in a diagonal direction.

7. A theater center apparatus as recited in claim 6, wherein said wing regions include flanks supporting additional speakers having respective drivers extending along a different axis than said pair of speakers.

8. A theater center apparatus as recited in claim 7, wherein the flanks are moveable relative to the front wall of the intermediate chamber.

9. A theater center apparatus as recited in claim 8, wherein the rear ends of the flanks are pivotally mounted to the rear wall and the opposite front ends of the flanks are removeably or slidably coupled to reinforcing ribs.

10. A theater center apparatus as recited in claim 7, wherein each of said wing regions includes dove-shaped sidewalls configured as two inwardly converging flanks.

11. A theater center apparatus as recited in claim 3, wherein the space between the intermediate platform and the bottom is substantially open so as to permit a person to easily insert and remove theater components.
